(19) United States
(12) Patent Application Publication
(10) Pub. No.: US 2012/0232958 A1
(43) Pub. Date: Sep. 13, 2012

(54) SYSTEMS AND METHODS FOR DYNAMIC VENUE DEMOGRAPHICS AND MARKETING

(75) Inventor: Benjamin Silbert, New York, NY (US)

(73) Assignee: BAR & CLUB STATISTICS, INC., New York, NY (US)

(21) Appl. No.: 13/416,235

(22) Filed: Mar. 9, 2012

Related U.S. Application Data
(60) Provisional application No. 61/451,706, filed on Mar. 11, 2011.

(51) Int. Cl. G06Q 30/02

(52) U.S. Cl. 705/7.34; 705/7.33

(57) ABSTRACT

Systems and methods for acquiring, managing, providing, and/or utilizing information identifying and/or descriptive of patrons of a venue are provided.

### CROSS-REFERENCE TO RELATED APPLICATIONS

The present application claims benefit and priority under 35 U.S.C. §119(e) to, and is a non-provisional application of, U.S. Provisional Patent Application Ser. No. 61/451706 titled “PRODUCING PATRON DATA BASED ON IDENTIFICATION CARD SCANS” and filed on Mar. 11, 2011, the entirety of which is hereby incorporated herein by reference.

### BACKGROUND

Systems for acquiring identification information from patrons of a venue (e.g., an entertainment venue such as a bar or night club), such as systems provided by Servall Data Systems, Inc. of San Francisco, Calif. (http://www.servalldatasystems.com), are typically configured to scan a minimal amount of indentifying data. The minimization of scanned data is primarily conducted to comply with various privacy rules or laws associated with the venue. At least for this reason, services that provide statistics regarding the venue, such as the Hot Owl™ application (http://hotowl.com/nightowls.html) from Servall Data Systems, Inc. or the system described in U.S. Patent Application Publication No. 2006/0195361, are generally limited to providing indications of the estimated capacity of the venue and/or the statistical breakdown of the age and/or gender of patrons of the venue. These and other limitations of current systems reduce the capability to gain accurate and meaningful metrics regarding patrons and activities of patrons.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a perspective diagram of a system according to some embodiments;

FIG. 3 is a diagram of an example data storage structure according to some embodiments;

FIG. 4 is flow diagram of a method according to some embodiments;

FIG. 5 is a block diagram of an apparatus according to some embodiments; and

FIG. 6A, FIG. 6B, FIG. 6C, and FIG. 6D are perspective diagrams of example data storage devices according to some embodiments.

### DETAILED DESCRIPTION

I. Introduction

Embodiments described herein are descriptive of systems, apparatus, methods, and articles of manufacture for collecting, managing, processing, and utilizing information descriptive of patrons of a venue. Some embodiments comprise, for example, receiving (e.g., from a data gathering device at a venue) an indication of an identifier for each patron of a plurality of patrons of the venue and/or an indication of a status of each patron of the plurality of patrons of the venue. Some embodiments comprise determining (e.g., based on the identifiers of the patrons) demographic data descriptive of each patron of the plurality of patrons of the venue. Some embodiments comprise compiling (e.g., based on the demographic data descriptive of each patron of the plurality of patrons of the venue) a demographic summary descriptive of the venue. Some embodiments comprise receiving (e.g., from a mobile device operated by a user) a request for demographic information and/or transmitting (e.g., in response to the receiving of the request for the demographic information and/or to the mobile device operated by the user) a signal that causes the mobile device to display a graphical representation of the demographic summary descriptive of the venue.

II. Terms and Definitions

As utilized herein, the term “venue” may generally refer to and/or be descriptive of one or more places, areas, buildings, structures, and/or other objects that may be attended by one or more patrons. Venues may comprise, for example, entertainment and/or sports venues such as sports arenas, bars, night clubs, stadiums, casinos, theatres, arcades, etc. In some embodiments, a venue may comprise a non-entertainment venue such as a train, restaurant, aircraft, bus terminal, checkpoint, etc. According to some embodiments, a venue may be owned and/or operated by a particular entity—e.g., a venue entity. In some embodiments, a venue may comprise a plurality of venues or sub-venues. A particular hotel, entertainment complex, mall, or casino, for example, may comprise multiple venues such as multiple movie or show theaters, clubs, restaurants, etc.

Also as utilized herein, the term “patron” may generally may generally refer to and/or be descriptive of one or more individuals, groups of individuals, and/or entities attending, patronizing, and/or otherwise associated with one or more particular venues. A patron may, for example, comprise an individual attending a movie at a movie theatre venue and/or may comprise a member of a particular group staying at a hotel and/or attending dinner at a restaurant in a casino.

As utilized herein, the term “customer” may generally refer to and/or be descriptive of one or more individuals, groups, and/or entities that are provided and/or that utilize patron and/or venue data and/or metrics as described herein. A customer may comprise, for example, an individual that subscribes to receive and/or have access to patron data (e.g., demographics and/or statistics) descriptive of one or more venues. The customer may utilize the provided data in accordance with some embodiments to determine which venues to attend and/or at which times a venue may be desirable to attend. In some embodiments, a customer may comprise a patron—e.g., in the case that a patron of a venue is provided with and/or utilizes patron and/or venue data and/or metrics (and/or in the cast that a customer chooses a venue to attend based on the provided data and then enters the chosen venue). In some embodiments, a customer may comprise a company such as a manufacture of a particular item sold (or offered) at a venue and/or a marketing entity. Such a customer may, for example, utilize the provided data to determine which venues to provide advertisements and/or promotions to.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal,. an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

III. Example Implementations

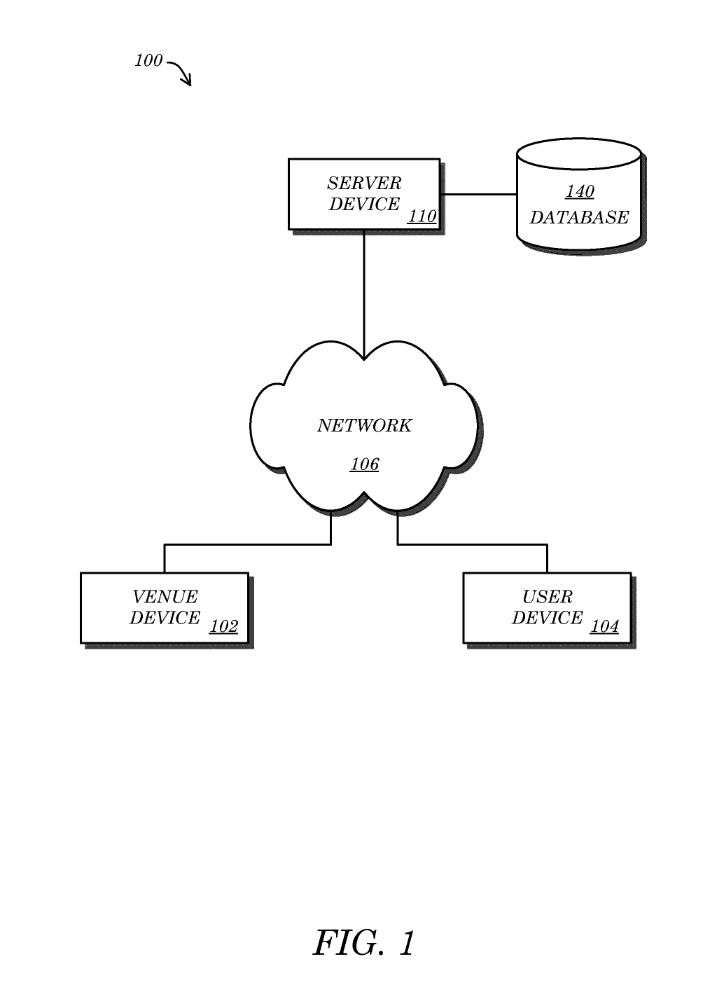

Referring first to FIG. 1, a block diagram of a system 100 according to some embodiments is shown. In some embodiments, the system 100 may comprise a venue device 102, a user device 104, a network 106, a server device 110, and/or a database 140. The venue device 102 may, in some embodiments, collect and/or store data descriptive and/or indicative of patrons of a venue (e.g., in which the venue device 102 is situated or disposed and/or otherwise coupled to). The venue device 102 may, for example, comprise one or more sensors, barcode and magnetic stripe readers, databases, and/or third-party data and/or sensing devices configured and/or situated to determine patron data. According to some embodiments, the venue device 102 may be in communication with the network 106. In some embodiments, the patron data gathered and/or stored by the venue device 102 can be queried, collected, sensed, looked-up, and/or otherwise obtained and/or determined by the server device 110 and/or by the user device 104 (e.g., either or both via the network 106). The server device 110 and/or by the user device 104 may, for example, comprise one or more computers, mobile computing devices, and/or servers in communication with the venue device 102 (e.g., via the network 106). The server device 110 may, in some embodiments, utilize the patron data from the venue device 102 to determine one or metrics regarding the venue. In some embodiments, the server device 110 may offer the patron data and/or venue metrics for sale and/or subscription to various entities, for various purposes—such as via the user device 104. In some embodiments, the server device 110 (and/or the venue device 102 and/or the user device 104) may be in communication with the database 140. The database 140 may store, for example, patron data obtained from the venue device 102, venue metrics defined by the server device 110, and/or instructions that cause various devices (e.g., the server device 110 and/or the location venue device 102) to operate in accordance with embodiments described herein.

The venue device 102, in some embodiments, may comprise any type, configuration, and/or combination of sensor, computing, mobile electronic, network, user, and/or communication device capable of obtaining and/or providing patron data that is or becomes known or practicable. The venue device 102 may, for example, comprise one or more identification scanning and/or entry-control devices such as a HotScan™ Chameleon™ and/or DragonFly™ IDentification (ID) scanning device or system available from Servall Data Systems, Inc. In some embodiments, the venue device 102 may comprise one or more of a digital or analog camera/video device (e.g., a Closed-Circuit TV (CCTV) camera, a webcam, satellite imaging device, aerial imaging device, robotic imaging device, and/or a Pan-Tilt-Zoom (PTZ)-enabled camera), an optical sensor, a laser sensor, a RADAR, LADAR; or SONAR sensor, a thermal sensor, an electrical current sensor, an electro and/or magnetic field sensor, a distance sensor, an acoustic sensor, any other type of sensor, and/or any combinations thereof. In some embodiments, the venue device 102 may comprise a tracking device that is coupled to/carried by patrons, e.g., cell phones or Personal Digital Assistant (PDS) devices (and/or location determining hardware and/or software thereof or associated therewith), or the like, RFID tags, or other location tracking devices located on or within patrons or objects, or on or within clothing or items (e.g., jewelry, watches, etc.) attached to patrons or objects, and capable of monitoring, storing and/or transmitting patron and/or venue data. In some embodiments, the venue device 102 may be coupled and/or configured to receive, determine, sense, gather, aggregate, store, process, and/or provide access to (e.g., via the network 106) patron and/or venue data associated with and/or descriptive of one or more venues.

The user device 104 may, according to some embodiments, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif.. In some embodiments, the user device 104 may comprise a device owned and/or operated by a user (not shown) of the patron and/or venue data available from the venue device 102 (e.g., directly from the venue device 102, from the server device 110, and/or via the network 106).

The network 106 may, according to some embodiments, comprise a Local Area Network (LAN; wireless and/or wired), Wide Area Network (WAN; wireless and/or wired), cellular telephone network, Bluetooth® network, Near-Field Communication (NFC) network, and/or Radio Frequency (RF) network with communication links between the venue device 102, the user device 104, the server device 110, and/or the database 140. In some embodiments, the network 106 may comprise direct communication links between any or all of the components 102, 104, 110, 140 of the system 100. The server device 110 may, for example, be directly interfaced or connected to the database 140 via one or more wires, cables, wireless links, and/or other network components, such network components (e.g., communication links) comprising portions of the network 106. In some embodiments, the network 106 may comprise one or many other links or network components other than those depicted in FIG. 1. The a user device 104 may, for example, be connected to the server device 110 via various cell towers, routers, repeaters, ports, switches, and/or other network components that comprise the Internet and/or a cellular telephone (and/or Public Switched Telephone Network (PSTN)) network, and which comprise portions of the network 106.

While the network 106 is depicted in FIG. 1 as a single object, the network 106 may comprise any number, type, and/or configuration of networks that is or becomes known or practicable. According to some embodiments, the network 106 may comprise a conglomeration of different sub-networks and/or network components interconnected, directly or indirectly, by the components 102, 104, 110, 140 of the system 100. The network 106 may comprise one or more cellular telephone networks with communication links between the venue device 102 and the server device 110, for example, and/or may comprise the Internet, with communication links between the user device 104 and the database 140, for example.

In some embodiments, the server device 110 may comprise an electronic and/or computerized controller device such as a computer server communicatively coupled to interface with the venue device 102, the user device 104, and/or the database 140 (directly and/or indirectly, such as via the network 106). The server device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the server device 110 may be located remote from one or more of the venue device 102, the user device 104, and/or the database 140. The server device 110 may also or alternatively comprise a plurality of electronic processing devices located at one or more various sites and/or locations.

According to some embodiments, the server device 110 may store and/or execute specially programmed instructions to operate in accordance with embodiments described herein. The server device 110 may, for example, execute one or more programs that facilitate the collection, aggregation, processing, determination, calculation, management, storing, and/or providing of patron and/or venue data and/or venue (or patron) metrics. According to some embodiments, the server device 110 may comprise a computerized processing device such as a PC, laptop computer, computer server, and/or other electronic device configured to manage and/or facilitate access to patron and/or venue data and/or metrics (e.g., by the venue device 102 and/or by the user device 104).

According to some embodiments, the server device 110 may comprise a device (or system) owned and/or operated by or on behalf of or for the benefit of a venue data service provider. The venue data service provider may utilize patron and/or venue data and/or venue metrics, in some embodiments, to inform customers (e.g., a user of the user device 104 and/or an owner or operator of the venue) regarding venue status (or likely status), patron status, and/or patron activities, trends, etc. Patron and/or venue data may, for example, be utilized to target advertising and/or manufacturer promotions to specific venues, specific patrons (or groups of patrons), at specific times. Patron and/or venue data may, in some embodiments, be provided to users based on user-defined preferences and/or stored rules such that the users may utilize the data to plan which venue to attend and/or when to attend a venue.

In some embodiments, the database 140 may comprise any type, configuration, and/or quantity of data storage devices that are or become known or practicable. The database 140 may, for example, comprise an array of optical and/or solid-state hard drives configured to store patron and/or venue data and/or metrics provided by the venue device 102 and/or the server device 110 (e.g., defined and/or determined by the server device 110), and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the venue device 102 and/or the user device 104 may comprise the database 140 or a portion thereof, for example, and/or the server device 110 may comprise the database 140 or a portion thereof.

In some embodiments, various user interfaces (not explicitly shown in FIG. 1) may be utilized to enhance the ability to comprehend or utilize patron and/or venue data and/or metrics. An application for a mobile device (such as an Apple® iPhone® application, for example) may, in some embodiments, provide a visual indication of patron and/or venue data and/or metrics gathered by (and/or from) the venue device 102 and/or processed by the server device 110. According to some embodiments, patron and/or venue data and/or metrics may be depicted visually on a map and/or as a layer on a map, such as may be provided, for example, by Google® Maps. Such visually-depicted patron and/or venue data (or metrics) may comprise real-time, delayed, historical (e.g., historical aggregate, average, trend), and/or predicted data. In such a manner, for example, a customer of patron and/or venue data and/or metrics may utilize a mobile and/or other device (e.g., the user device 104) to view a map (and/or other graphical depiction) of patron and/or venue data and/or metrics and utilize the map to inform, facilitate, and/or conduct decision-making processes.

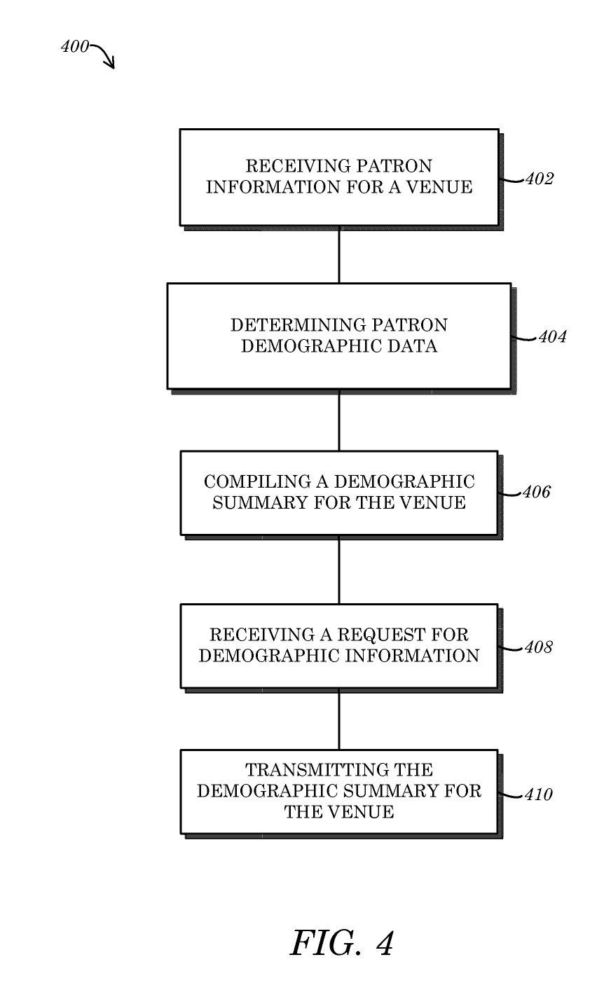

Fewer or more components 102, 104, 106, 110, 140 and/or various configurations of the depicted components 102, 104, 106, 110, 140 may be included in the system 100 without deviating from the scope of embodiments described herein. In some embodiments, the components 102, 104, 106, 110, 140 may be similar in configuration and/or functionality to similarly named and/or numbered components as described herein. In some embodiments, the system 100 (and/or portion thereof, such as the server device 110) may be programmed to and/or may otherwise be configured to execute, conduct, and/or facilitate the method 400 of FIG. 4 and/or portions or combinations thereof described herein.

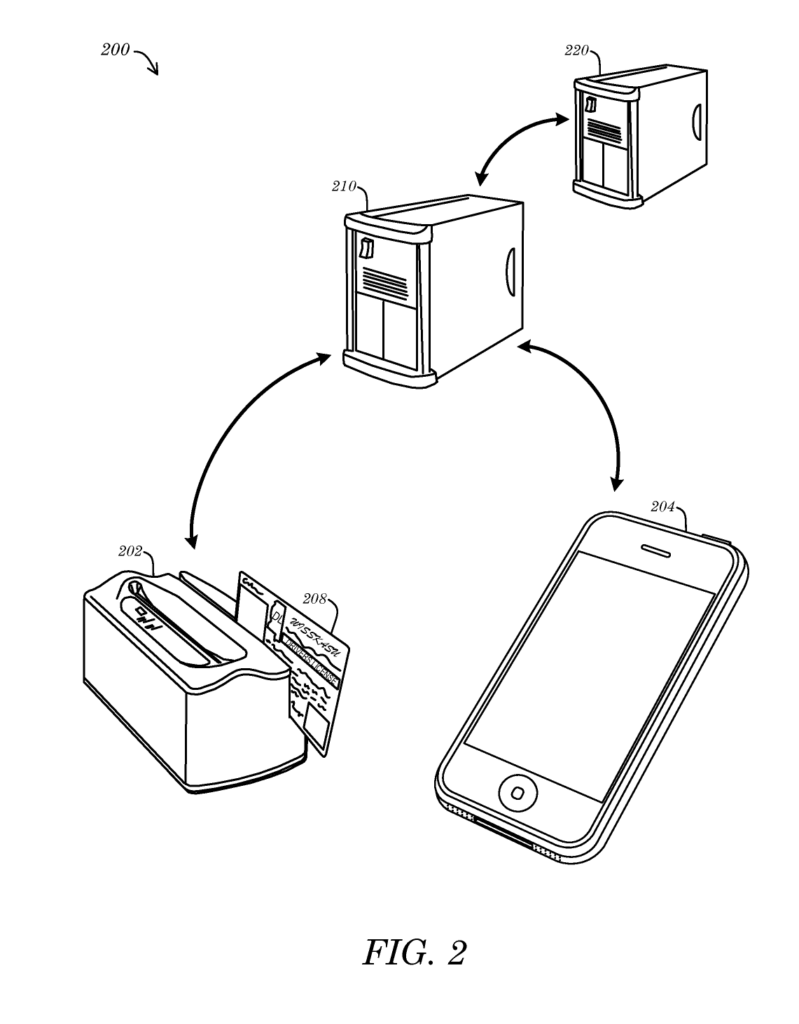

Turning now to FIG. 2, a perspective diagram of a system 200 according to some embodiments is shown. In some embodiments, the system 200 may acquire, gather, store, process, analyze, disseminate, and/or otherwise determine and/or provide patron and/or venue data and/or metrics. The system 200 may, for example, be similar in configuration and/or functionality to the system 100 of FIG. 1 herein. According to some embodiments, the system 200 may comprise an ID scanner 202, a customer device 204, a patron ID 208, a central controller 210, and/or a third-party device 220.

According to some embodiments, the ID scanner 202 may be utilized to scan the patron ID 208 (e.g., in, at, and/or in association with a particular venue, not explicitly shown in FIG. 2). The ID scanner 202 may, for example, comprise a bar code reader, magnetic stripe reader, NFC receiver (or transceiver), Bluetooth® device, and/or other optical, magnetic, passive-inductive, and/or proximity sensor configured and/or coupled to read information from the patron ID 208. In some embodiments, the ID scanner 202 may read any desirable and/or practicable quantity and/or type of information available from the patron ID 208.

The patron ID 208 may comprise, for example, a driver's license, passport, social security and/or other government identification card, credit card, account card, security token, pass-key, or the like, storing data identifying and/or descriptive of one or more patrons of a venue. In the case of a drivers license, for example, the patron ID 208 may store information descriptive of a particular patron such as Date of Birth (DoB), height, weight, age, gender, mailing address, a photograph, license type, and/or an organ donor indicator. Other information such as a loyalty program identifier (e.g., frequent flyer and/or frequent shopper identifiers), group identifier, stored value, and/or third-party rules or restrictions may also or alternatively be stored and/or indicated by the patron ID 208. The information may be stored and/or indicated in any manner that is or becomes known or practicable. The patron ID 208 may comprise, for example, a magnetic stripe, barcode (e.g., 2-D and/or 3-D barcode; e.g., a 2-D matrix barcode such as Quick Response (QR) code), RFID tag, and/or other NFC information device that stores identifying and/or descriptive information.

In some embodiments, the ID scanner 202 may read and/or scan any desired and/or available data from the patron ID 208. The ID scanner 202 may be utilized, for example, at a point of entry/exit at a venue to scan the patron ID 208 upon the patron entering and/or exiting the venue. The ID scanner 202 may; in some embodiments, time-stamp the scanning and/or data acquisition. According to some embodiments, the ID scanner 202 may store the time-stamp in association with any data received from the patron ID 208. Although not explicitly shown in FIG. 2, for example, the ID scanner 202 may comprise a memory device and/or may store an identifier or pointer to a location in an external memory device (e.g., at the central controller 210). In some embodiments, the ID scanner 202 may assign an identifier, pseudonym, and/or tag to represent the received (and/or retrieved) patron data (e.g., a patron ID tag). The ID scanner 202 may, for example assign an encoded code such as a cryptographic hash tag to anonymously associated the patron associated with the patron ID 208 to the gathered patron data.

According to some embodiments, the ID scanner 202 may provide the patron data (e.g., scanned data, time-stamp data, and/or patron ID tag) to the central controller 210. The ID scanner 202 may transmit the data to the central controller 210 (and the central controller 210 may accordingly receive the data) at intervals and/or upon request, for example, or the central controller 210 may query and/or pull the data from the ID scanner 202. The central controller 210 may, in some embodiments, process the patron data received and/or retrieved from the ID scanner 202. The central controller 210 may, for example execute stored instructions that cause the calculation and/or determination (e.g., lookup and/or other derivation) of one or more patron and/or venue metrics based on the patron data. For example, the central controller 210 may calculate, based on the patron data, various real-time statistics such as, but not limited to, the current male-female ration of patrons of the venue, the number of patrons entering or leaving the venue per unit of time, total current patron count and/or ratio of current patrons to maximum number of patrons (e.g., venue capacity), the median (or average) age, height, and/or weight of current patrons of the venue, etc.

In some embodiments, the central controller 210 may communicate with the third-party device 220. The third-party device 220 may, for example, comprise a device owned and/or operated by and/or on behalf of a third-party (e.g., a party that is not an owner and/or operator of the ID scanner 202, the central controller 210, and/or the mobile customer device 204) such as a demographics and/or other information provider. The third-party device 220 may, in some embodiments, comprise a device associated with a government and/or municipal entity (e.g., the U.S. Census Bureau and/or a County or Town Assessors' Office) and/or a marketing and/or demographic data provider such as ERSI® of Redlands, Calif. and/or the Nielsen Company® of New York, N.Y.. The central controller 210 may, according to some embodiments, retrieve (and/or receive) demographic data associated with the patron ID 208 from the third-party device 220. In the case that the patron ID 208 comprises an indication of a mailing address and/or postal zip code, for example, the central controller 210 may query the third-party device 220 utilizing the address or a portion thereof such as the postal zip code to determine various location-based demographics associated with the patron of the venue. The postal zip code may be utilized, for example, to determine median income levels, percentage of residents that own their own homes, racial, ethnic, and/or religious distributions, etc. In some embodiments, the central controller 210 may utilize third-party demographic data to determine one or metrics associated with a particular patron and/or group of patrons (such as a likelihood/probability that the patron is a homeowner).

According to some embodiments, the central controller 210 may provide the patron and/or venue data and/or metrics to the customer device 204. The customer device 204 may, for example, comprise a device (e.g., a mobile device as depicted and/or a different type or configuration of electronic and/or computing device) owned and/or operated by and/or on behalf of one or more customers. In some embodiments, the customer device 204 may be utilized to retrieve and/or receive patron and/or venue data and/or metrics from the central controller 210. The central controller 210 may provide to the customer device 204, for example, one or more tables, graphs, matrices, charts, and/or other graphical representations of patron and/or venue data and/or metrics. In some embodiments, the customer device 204 may receive and display, for example, graphical indications of how many patrons are currently attending a particular venue, what the age, weight, and/or height distribution of the patrons attending the venue is, and/or where the patrons in the venue are from (e.g., country, state, and/or postal zip code), or what the average likely income of the patrons attending the venue is. These and other patron and/or venue data points and/or metrics may be provided with respect to current (e.g., real-time) venue status and/or with respect to historic venue status. A customer utilizing the customer device 204 may query the central controller 210, for example, to determine for a particular venue (or group of venues) what percentage of patrons have been from Texas or what percentage of patrons have ordered a particular brand of beverage, on Friday nights, for example. In some embodiments, the customer may utilize such patron and/or venue data and/or metrics (current and/or historic) to determine whether to provide an advertisement and/or promotion to the venue (or group of venues) and/or to determine which of a plurality of available advertisements and/or promotions should be provided, and/or at what times.

Fewer or more components 202, 204, 208, 210, 220 and/or various configurations of the depicted components 202, 204, 208, 210, 220 may be included in the system 200 without deviating from the scope of embodiments described herein. While a single ID scanner 202 is depicted in FIG. 2, for example, multiple ID scanners 202 may be included in the system 200 in association with a single venue or in association with a plurality of venues. Similarly, while only a single customer device 204 is depicted in FIG. 2, multiple customer devices 204 may be included in the system 200 in association with a single customer or in association with a plurality of customers.

In some embodiments, the components 202, 204, 208, 210, 220 may be similar in configuration and/or functionality to similarly named and/or numbered components as described herein. In some embodiments, the system 200 (and/or a portion thereof and/or a component in communication therewith) may be programmed to and/or may otherwise be configured to execute, conduct, and/or facilitate the method 400 of FIG. 4 and/or portions or combinations thereof described herein.

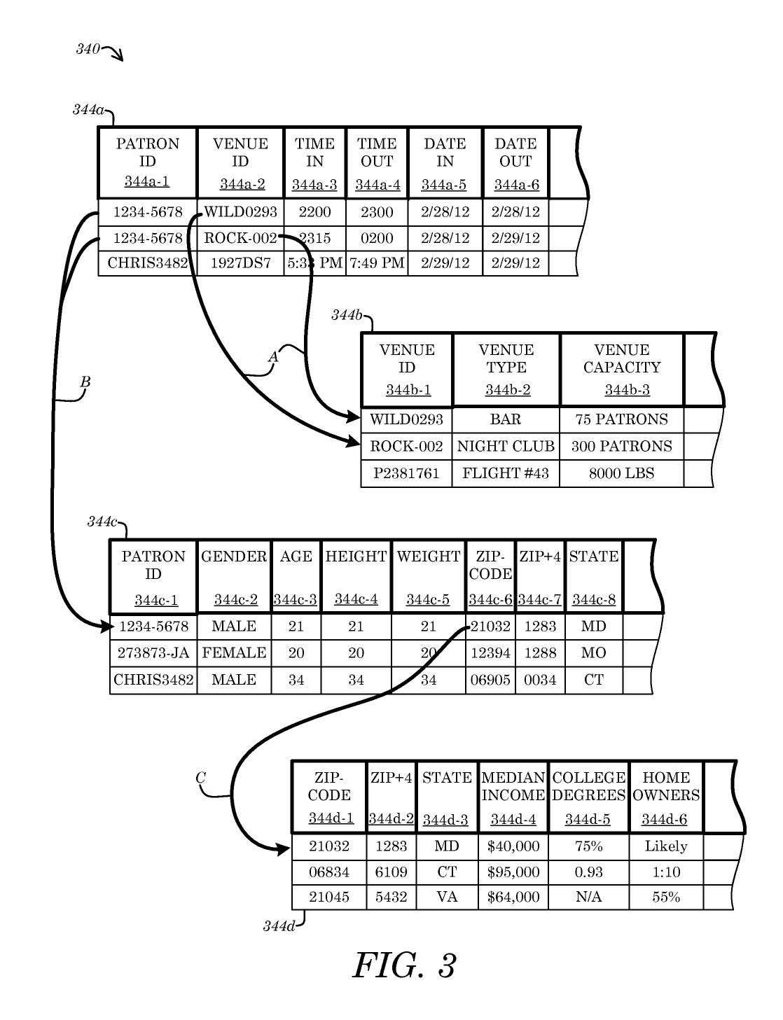

Referring now to FIG. 3, a diagram of an example data storage structure 340 according to some embodiments is shown. The example data storage structure 340 may comprise, according to some embodiments, a patron activity table 344a, a venue data table 344b, a patron data table 344c, and/or a demographics data table 344d. The patron activity data table 344a may, in some embodiments, store information descriptive of one or more activities and/or actions of a patron. The patron activity data table 344a may comprise, for example, a patron ID field 344a-1, a venue ID field 344a-2, a time in field 344a-3, a time out field 344a-4, a date in field 344a-5, and/or a date out field 344a-6. In some embodiments, the patron ID field 344a-1 may store an encoded and/or encrypted identifier (e.g., a unique identifier) representing a particular patron.

In some embodiments, the venue data table 344b may store information descriptive of a venue. The venue data table 344b may comprise, for example, a venue ID field 344b-1, a venue type field 344b-2, and/or a venue capacity field 344b-3. According to some embodiments, the patron data table 344c may store information descriptive of one or more attributes of a patron. The patron data table 344c may comprise, for example, a patron ID field 344c-1, a gender field 344c-2, an age field 344c-3, a height field 344c-4, a weight field 344c-5, a zip-code field 344c-6, a zip+4 field 344c-7, and/or a state field 344c-8. According to some embodiments, the data stored in the patron data table 344c may comprise data retrieved from a patron ID (such as the patron ID 208 of FIG. 2) and/or received from a device configured to read/scan a patron ID (such as the ID scanner 202 of FIG. 2).

In some embodiments, the demographics data table 344d may store information descriptive of demographics associated with one or more metrics such as postal zip code, as depicted. The demographics data table 344d may comprise, for example, a zip-code field 344d-1, a zip+4 field 344d-2, a state field 344d-3, a median income field 344d-4, a college degrees field 344d-5, and/or a home owners field 344d-6. In some embodiments, the data stored in the demographics data table 344d may comprise data of a third-party and/or received from a third-party device (such as the third-party device 220 of FIG. 2).

According to some embodiments, the various example data tables 344a-d of the example data storage structure 340 may be linked to establish and/or define relationships there between. A first relationship “A” may be established, for example, between the patron data table 344a and the venue data table 344b, utilizing the venue ID fields 344a-2, 344b-1. The venue ID fields 344a-2, 344b-1 may be utilized as a key, for example, linking the activity records for various patrons stored in the patron data table 344a to detailed information regarding the corresponding venues stored in the venue data table 344b. According to some embodiments, the first relationship “A” may comprise any type of data relationship that is or becomes desirable, such as a one-to-many, many-to-many, or many-to-one relationship. In the case that multiple patrons are likely to frequent/attend a particular venue for example, the first relationship “A” may comprise a many-to-one relationship (e.g., many patrons per single venue). In some embodiments, such as depicted in the example data storage structure 340 of FIG. 3, a single patron may frequent/attend multiple venues and/or the first relationship “A” may comprise a one-to-many relationship—such as the two patron records (for patron ID 344a-1 “1234-5678”) in the patron activity table 344a that are depicted as linking to the venue table 344b via the first relationship “A”). In such a manner, for example, a patron may be associated with the venues that the patron has attended. In some embodiments, such as in the case that the patron ID field 433a-1 stores an encoded code and/or cryptographic hash tag representing a particular patron, the patron's activities may be tracked and/or analyzed without comprising the privacy of the individual—e.g., the data stored in the example data storage structure 340 can be linked to a particular patron via the hash tag but the actual identity of the patron is indeterminable.

In some embodiments, a second relationship “B” may be established between the patron table 344a and the patron data table 344c. In some embodiments (e.g., as depicted in FIG. 3), the second relationship “B” may be defined by utilizing the patron ID field 344a-1 as a data key linking to the patron ID field 344c-1. According to some embodiments, the second relationship “B” may comprise any type of data relationship that is or becomes desirable, such as a one-to-many, many-to-many, or many-to-one relationship. In the case that multiple patron records are likely to exist in the patron activity table 344a for a single patron for example, the second relationship “B” may comprise a many-to-one relationship. In such a manner, for example, details such as attributes of a particular patron may be associated with particular venues which the patron has frequented/attended.

According to some embodiments, a third relationship “C” may be established between the patron data table 344c and the demographics data table 344d. In some embodiments (e.g., as depicted in FIG. 3), the third relationship “C” may be defined by utilizing the zip-code field 344c-6 (and/or zip+4 field 344c-7 and/or the state field 344c-8) as a data key linking to the zip-code field 344d-1 (and/or zip+4 field 344d-2 and/or the state field 344d-3). According to some embodiments, the third relationship “C” may comprise any type of data relationship that is or becomes desirable, such as a one-to-many, many-to-many, or many-to-one relationship. In the case that multiple patrons are likely to reside in a single postal zip code, zip+4,and/or state for example, the third relationship “C” may comprise a many-to-one relationship. In such a manner, for example, demographic data associated with a location where a patron lives/works/etc. may be utilized to determine characteristics of various patrons and/or groups of patrons.

Utilizing the first, second, and/or third relationships, “A”, “B”, and/or “C”, it may accordingly be possible to readily identify various demographic characteristics of patrons attending (or who have historically attended) a particular venue (or group of venues). Such information may be utilized, as described herein, to inform and/or conduct various decision-making processes such as to determine whether to serve an advertisement and/or promotion to patrons of a particular venue (and/or at what time(s)), to determine which advertisement and/or promotion from a plurality of available advertisements and/or promotions to serve to a particular venue and/or group of patrons (and/or at what time(s)), and/or to determine which venue to visit and/or at which time to visit (and/or how long to stay, etc.).

In some embodiments, fewer or more data fields than are shown may be associated with the data tables 344a-d. Only a portion of one or more databases and/or other data stores is necessarily shown in FIG. 3, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

Turning to FIG. 4, a flow diagram of a method 400 according to some embodiments is shown. In some embodiments, the method 400 may be performed and/or implemented by and/or otherwise associated with one or more specialized and/or computerized processing devices, specialized computers, computer terminals, computer servers, computer systems and/or networks, and/or any combinations thereof (e.g., the server device 110 of FIG. 1 and/or the central controller 210 of FIG. 2). In some embodiments, the method 400 may be embodied in, facilitated by, and/or otherwise associated with various input mechanisms and/or interfaces. In some embodiments, the components 402, 404, 406, 408, 410 of the method 400 may be similar in configuration and/or functionality to similarly named and/or numbered components as described herein.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 400 may be illustrative of a process implemented to acquire, manage, and/or disseminate and/or utilize patron and/or venue data and/or metrics as described herein. According to some embodiments, the method 400 may comprise receiving patron information for a venue, at 402. The method 400 may comprise, for example, receiving (e.g., by a central controller device and/or from a data gathering device at a remote venue) an indication of an identifier for each patron of a plurality of patrons of the venue and/or an indication of a status of each patron of the plurality of patrons of the venue. One or more ID scanners (e.g., the ID scanner 202 of FIG. 2) situated at the entry/exit points of a night club, for example, may scan patron ID data as patrons enter and/or exit the night club. The data may be stored and/or provided to a central controller and/or database, either of which may, for example, receive the scanned data. In some embodiments, the data may include an indication of a status of a patron such as whether the patron has entered the night club, whether they have exited the night club, whether they are in a restroom (or other particular room or area), and/or whether they have ordered and/or purchased one or more items (e.g., a number, brand, and/or type of beverage). In some embodiments, such as where patron anonymity and/or privacy is to be protected, the information may be received in association with an encoded code (such as a cryptographic hash tag) that is utilized to represent a particular patron and/or group of patrons.

According to some embodiments, the method 400 may comprise determining patron demographic data, at 404. The method 400 may comprise, for example, determining (e.g., by a central controller device and/or based on the identifiers of the patrons) demographic data descriptive of each patron of the plurality of patrons of the venue. In some embodiments, some or all of the demographic data may be received at 402. A data gathering device at the venue may read an ID of a patron and/or otherwise determine the patron's weight, for example, and provide weight as a demographic data point. According to some embodiments, some or all of the demographic data may be retrieved and/o received (e.g., in response to a query) based on identifying and/or demographic data received from the venue. As utilized in the on-going example herein, for example, a mailing address and/or portion thereof may be utilized to query third-party data sources to determine various characteristics and/or likelihoods of characteristics applying to a particular patron.

In some embodiments, the method 400 may comprise compiling a demographic summary for the venue, at 406. The method 400 may comprise, for example, compiling (e.g., by a central controller device and/or based on the demographic data descriptive of each patron of the plurality of patrons of the venue) a demographic summary descriptive of the venue. One or more demographic metrics such as (i) what percentage of patrons of the venue are female, (ii) what percentage of patrons of the venue are from a particular country, state, and/or town, and/or (iii) what the probability is that a certain number and/or percentage of patrons of the venue earn over one hundred thousand dollars a year ($100,000/yr), may for example be calculated, derived, defined, and/or looked-up (e.g., based on the information received at 402 and/or determined at 404). In some embodiments, the demographic summary may comprise “raw” and/or list information descriptive of patrons attending a venue. In the case that anonymous tags are utilized to identify patron information, for example, individual patron information may be provided to a customer as a “summary” without compromising the identify and/or privacy of any individual patron—while a customer may readily determine if a twenty-nine (29) year old male from Kansas over six feet (6′) tall is in (or has been in) a particular venue.

According to some embodiments, the method 400 may comprise determining receiving a request for demographic information, at 408. The method 400 may comprise, for example, receiving (e.g., by a central controller device and/or from a mobile device operated by a user) a request for demographic information. In some embodiments, such as in the case that users/customers are charged for accessing demographic information, a login and/or verification process may be initiated to determine if (and/or to what extent) a particular customer (e.g., from which the request at 408 is received) should be allowed to access the requested information. In some embodiments, customers may be charged (e.g., annually) for access—e.g., payment may be received. According to some embodiments, the request may indicate one or more venues for which demographic information is desired. In some embodiments, one or more venues from a plurality of possible venues may be selected on behalf of the customer—e.g., based on a location of the customer and/or a device operated by the customer and/or based on customer preferences. In some embodiments, the request may comprise an indication of one or more preferences. The request may, for example, indicate that the customer wants to know which local bars are historically (or currently) frequented by lawyers (e.g., profession information may be gathered from various third-party data sources). Demographic data associated with various venues and/or patrons may, in response to the request, be sorted, ranked, filtered, and/or otherwise processed to determine a subset of data that satisfies the customer preference(s).

In some embodiments, the method 400 may comprise transmitting the demographic summary for the venue, at 410. The method 400 may comprise, for example, transmitting (e.g., in response to the receiving of the request for the demographic information at 408 and/or by a central controller device and/or to a mobile device operated by the user) a signal that causes a mobile device to display a graphical representation of the demographic summary descriptive of the venue. A graphical user interface may be provided to a customer, for example, via which desired demographic data may be output for consideration and/or use by the customer.

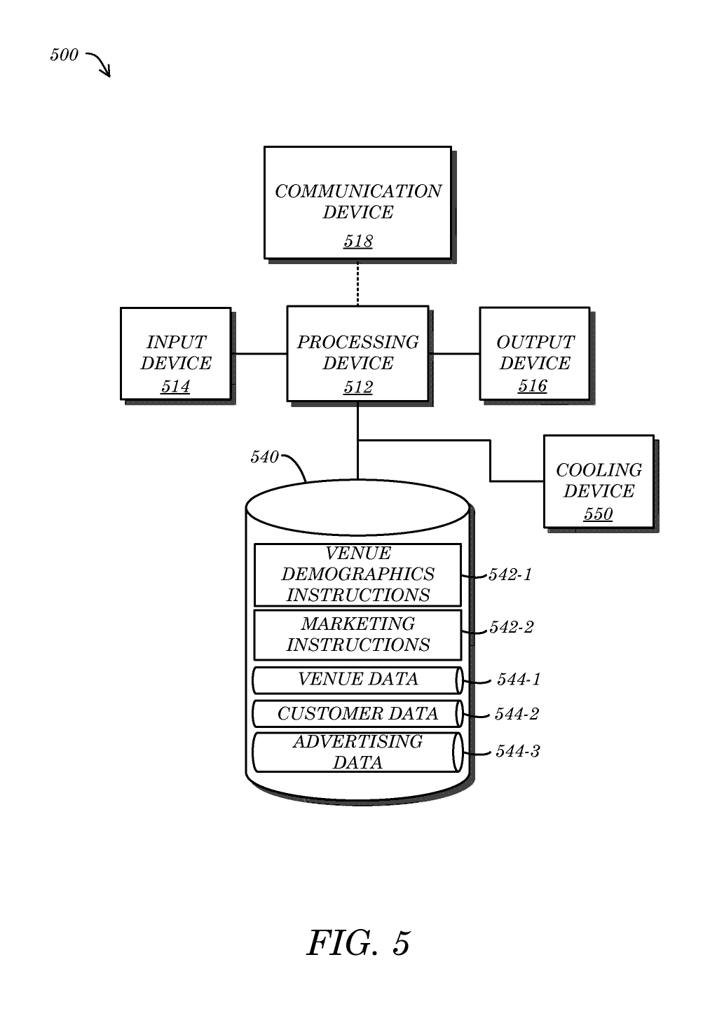

Turning to FIG. 5, a block diagram of an apparatus 510 according to some embodiments is shown. In some embodiments, the apparatus 500 may be similar in configuration and/or functionality to the server device 110, the venue device 102, and/or the user device 104 of FIG. 1 herein and/or the ID scanner 202, the customer device 204, and/or the central controller 210 of FIG. 2 herein. The apparatus 500 may, for example, execute, process, facilitate, and/or otherwise be associated with the method 400 of FIG. 4, and/or may output or provide various interfaces. In some embodiments, the apparatus 500 may comprise processing device 512, an input device 514, an output device 516, a communication device 518, and/or a memory device 540. Fewer or more components 512, 514, 516, 518, 540 and/or various configurations of the components 512, 514, 516, 518, 540 may be included in the apparatus 500 without deviating from the scope of embodiments described herein. In some embodiments, the components 512, 514, 516, 518, 540 of the apparatus 500 may be similar in configuration and/or functionality to similarly named and/or numbered components as described herein.

According to some embodiments, the processing device 512 may be or include any type, quantity, and/or configuration of electronic and/or computerized processor that is or becomes known. The processing device 512 may comprise, for example, an Intel® IXP 2800 network processor or an Intel® XEON™ Processor coupled with an Intel® E7501 chipset. In some embodiments, the processing device 512 may comprise multiple inter-connected processors, microprocessors, and/or micro-engines. According to some embodiments, the processing device 512 (and/or the apparatus 500 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 500 comprises a server such as a blade server, necessary power may be supplied via a standard AC outlet, power strip, surge protector, and/or Uninterruptible Power Supply (UPS) device.

In some embodiments, the input device 514 and/or the output device 516 are communicatively coupled to the processing device 512 (e.g., via wired and/or wireless connections, traces, and/or pathways) and they may generally comprise any types or configurations of input and output components and/or devices that are or become known, respectively. The input device 514 may comprise, for example, a keyboard that allows an operator of the apparatus 500 to interface with the apparatus 500 (e.g., a customer of patron and/or venue data, such as to implement marketing, advertising, and/or decision-making processes based on such data). The output device 516 may, according to some embodiments, comprise a display screen and/or other practicable output component and/or device. The output device 516 may, for example, provide patron and/or venue data and/or metrics (e.g., via a website and/or via a computer workstation). According to some embodiments, the input device 514 and/or the output device 516 may comprise and/or be embodied in a single device such as a touch-screen monitor.

In some embodiments, the communication device 518 may comprise any type or configuration of communication device that is or becomes known or practicable. The communication device 518 may, for example, comprise a Network Interface Card (NIC), a telephonic device, a cellular network device, a router, a hub, a modem, and/or a communications port or cable. In some embodiments, the communication device 518 may be coupled to receive and/or provide patron and/or venue demographic information in accordance with embodiments described herein. According to some embodiments, the communication device 518 may also or alternatively be coupled to the processing device 512. In some embodiments, the communication device 518 may comprise an Infra-red Radiation (IR), Radio Frequency (RF), Bluetooth)™, Near-Field Communication (NFC), and/or Wi-Fi® network device coupled to facilitate communications between the processing device 512 and one or more other devices.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of venue demographic instructions 542-1 and/or marketing instructions 542-2. In some embodiments, the venue demographic instructions 542-1 and/or marketing instructions 542-2 may be utilized by the processing device 512 to provide output information via the output device 516 and/or the communication device 518 (e.g., the transmitting of the demographic summary at 410 of the method 400 of FIG. 4).

According to some embodiments, the venue demographic instructions 542-1 may be operable to cause the processing device 512 to access venue data 544-1, customer data 544-2, and/or advertising data 544-3 (e.g., in accordance with the method 400 of FIG. 4 herein). Venue data 544-1, customer data 544-2, and/or advertising data 544-3 received via the input device 514 and/or the communication device 518 may, for example, be analyzed, sorted, filtered, decoded, decompressed, ranked, scored, plotted, and/or otherwise processed by the processing device 512 in accordance with the venue demographic instructions 542-1. In some embodiments, venue data 544-1, customer data 544-2, and/or advertising data 544-3 may be fed by the processing device 512 through one or more mathematical and/or statistical formulas, rule sets, policies, and/or models in accordance with the venue demographic instructions 542-1 to determine one or more demographic summaries/metrics for one or more venues (e.g., the compiling at 406 of the method 400 of FIG. 4) as described herein.

According to some embodiments, the marketing instructions 542-2 may be operable to cause the processing device 512 to access the venue data 544-1, customer data 544-2, and/or advertising data 544-3 (e.g., in accordance with the method 400 of FIG. 4 herein). Venue data 544-1, customer data 544-2, and/or advertising data 544-3 received via the input device 514 and/or the communication device 518 may, for example, be analyzed, sorted, filtered, decoded, decompressed, ranked, scored, plotted, and/or otherwise processed by the processing device 512 in accordance with the marketing instructions 542-2. In some embodiments, venue data 544-1, customer data 544-2, and/or advertising data 544-3 may be fed by the processing device 512 through one or more mathematical and/or statistical formulas, rule sets, policies, and/or models in accordance with the marketing instructions 542-2 to determine which advertisements and/or promotions should be provided to a venue, as described herein.

In some embodiments, the venue data 544-1 may comprise data including, but not limited to, data descriptive of one or more attributes of a venue such as capacity, venue type, etc. According to some embodiments, the customer data 544-2 may comprise data including, but not limited to, data descriptive of one or more patrons and/or customers such as which venue a patron is (or has been) in, which venues a customer is interested in receiving demographic summaries/metrics for, what demographics a particular customer prefers, etc. In some embodiments, the advertising data 544-3 may comprise data including, but not limited to, data descriptive of rules for providing advertisements and/or promotions (such as which demographic scenarios warrant outputting a particular advertisement and/or promotion), advertisement content, and/or promotional content.

In some embodiments, the apparatus 500 may comprise a cooling device 550. According to some embodiments, the cooling device 550 may be coupled (physically, thermally, and/or electrically) to the processing device 512 and/or to the memory device 540. The cooling device 550 may, for example, comprise a fan, heat sink, heat pipe, radiator, cold plate, and/or other cooling component or device or combinations thereof, configured to remove heat from portions or components of the apparatus 500.

According to some embodiments, the apparatus 500 may generally function as a computer terminal and/or server of a demographic data provider, for example, which is utilized to collect, manage, process, and/or provide/sell access to demographic data descriptive of patrons and/or venues. In some embodiments, the apparatus 500 may comprise a web server and/or other portal (e.g., an Interactive Voice Response Unit (IVRU)) that provides patron and/or venue data and/or metrics to customers and/or third-parties. According to some embodiments, the apparatus 500 may comprise and/or provide an interface via which users may visualize, model, and/or otherwise manage patron and/or venue data and/or metrics and/or to inform and/or define marketing, advertising, and/or other decision making processes.

Any or all of the exemplary instructions and data types described herein and other practicable types of data may be stored in any number, type, and/or configuration of memory devices that are or become known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 500. According to some embodiments, the memory device 540 may be incorporated into and/or otherwise coupled to the apparatus 500 (e.g., as shown) or may simply be accessible to the apparatus 500 (e.g., externally located and/or situated). In some embodiments, fewer or more data elements 544-1, 544-2, 544-3 and/or types than those depicted may be necessary and/or desired to implement embodiments described herein.

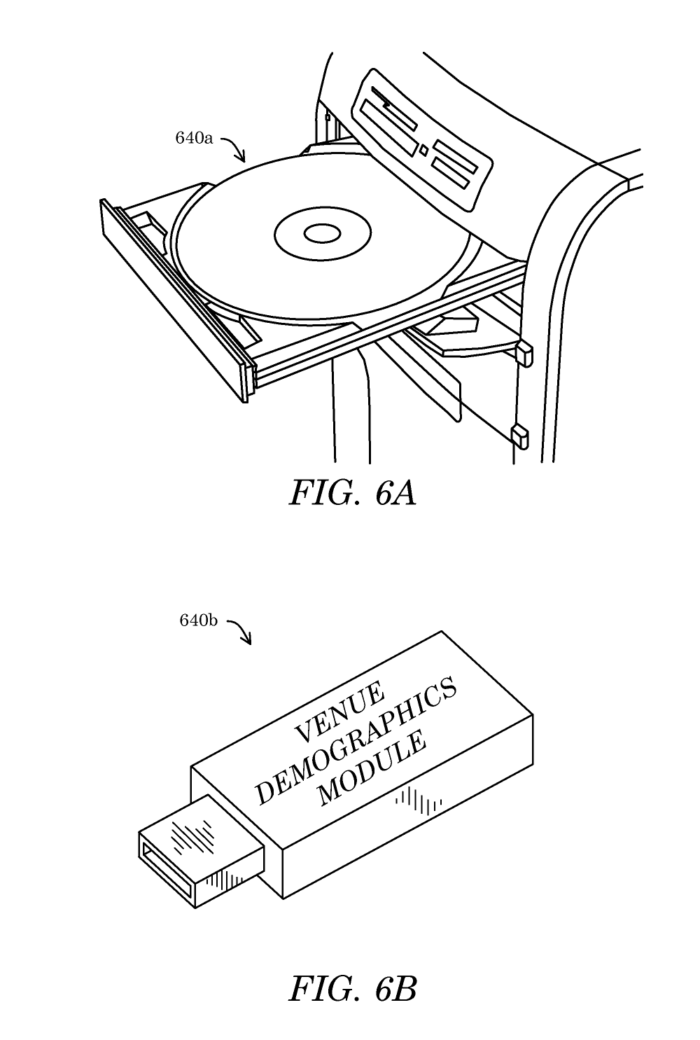

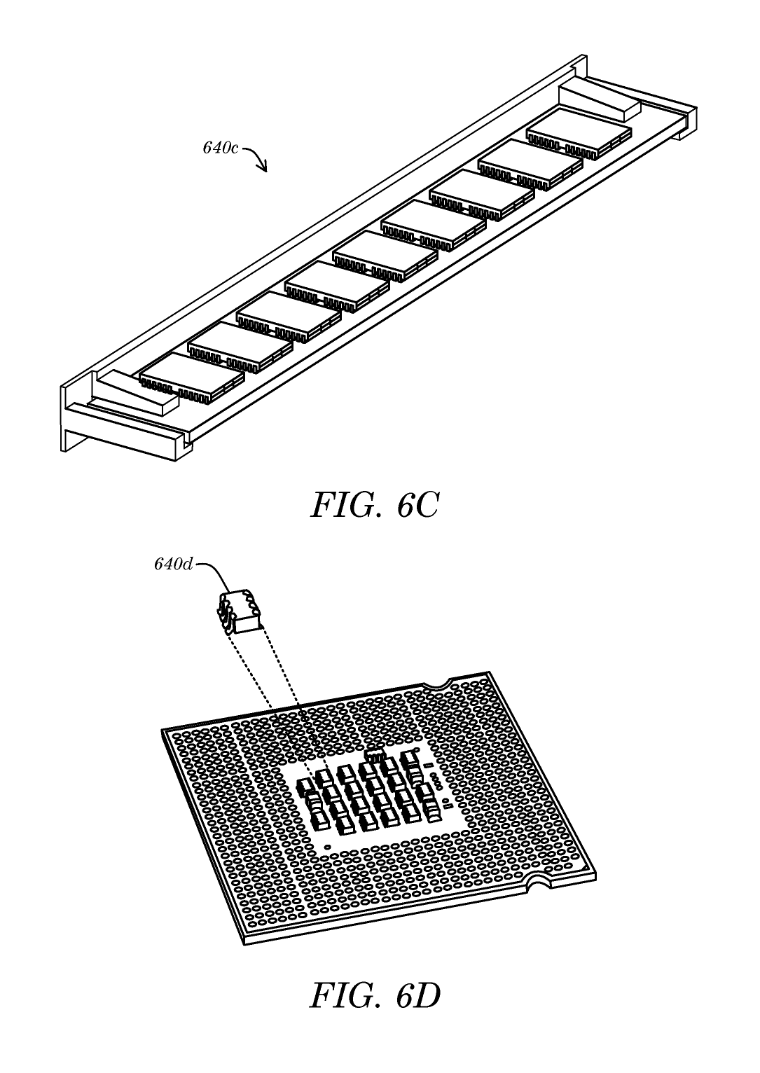

Referring now to FIG. 6A, FIG. 6B, FIG. 6C, and FIG. 6D, perspective diagrams of exemplary data storage devices 640a-d according to some embodiments are shown. The data storage devices 640a-d may, for example, be utilized to store instructions and/or data such as the venue data 544-1, customer data 544-2, and/or advertising data 544-3, each of which is described in reference to FIG. 5 herein. In some embodiments, instructions stored on the data storage devices 640a-d may, when executed by a processor (such as the processing device 512 of FIG. 5), cause the implementation of and/or facilitate the method 400 described in conjunction with FIG. 4, and/or portions thereof, as described herein.

According to some embodiments, the first data storage device 640a may comprise a CD, CD-ROM, DVD, Blu-Ray™ Disc, and/or other type of optically-encoded disk and/or other computer-readable storage medium that is or becomes know or practicable. In some embodiments, the second data storage device 640b may comprise a USB key fob, dongle, and/or other type of flash memory data storage device that is or becomes know or practicable. According to some embodiments, the third data storage device 640c may comprise RAM of any type, quantity, and/or configuration that is or becomes practicable and/or desirable. In some embodiments, the third data storage device 640c may comprise an off-chip cache such as a Level 2 (L2) or Level 3 (L3) cache memory device. According to some embodiments, the fourth data storage device 640d may comprise an on-chip memory device such as a Level 1 (L1) cache memory device.

The data storage devices 640a-d may generally store program instructions, code, and/or modules that, when executed by an electronic and/or computerized processing device cause a particular machine to function in accordance with embodiments described herein. In some embodiments, the data storage devices 640a-d depicted in FIG. 6A, FIG. 6B, FIG. 6C, and/or FIG. 6D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

IV. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restrict the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or . article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by a central controller device and from a data gathering device at a remote venue, an indication of an identifier for each patron of a plurality of patrons of the venue and an indication of a status of each patron of the plurality of patrons of the venue;
determining, by the central controller device and based on the identifiers of the patrons, demographic data descriptive of each patron of the plurality of patrons of the venue;
compiling, by the central controller device and based on the demographic data descriptive of each patron of the plurality of patrons of the venue, a demographic summary descriptive of the venue;
receiving, by the central controller device and from a mobile device operated by a user, a request for demographic information; and
transmitting in response to the receiving of the request for the demographic information, and by the central controller device and to the mobile device operated by the user, a signal that causes the mobile device to display a graphical representation of the demographic summary descriptive of the venue.

2. The method of claim 1, wherein the identifier for each patron of the plurality of patrons of the venue comprises an encoded identifier.

3. The method of claim 2, wherein the identifier for each patron of the plurality of patrons of the venue comprises an encrypted identifier.

4. The method of claim 3, wherein the identifier for each patron of the plurality of patrons of the venue comprises a cryptographic hash tag.

5. The method of claim 1, wherein the indication of the status of each patron of the plurality of patrons of the venue comprises an indication of whether each patron has entered or exited the venue.

6. The method of claim 1, wherein the determining of the demographic data descriptive of each patron of the plurality of patrons of the venue comprises:
receiving, by the central controller device and from the data gathering device at the remote venue, an indication of the demographic data descriptive of each patron of the plurality of patrons of the venue.

7. The method of claim 1, wherein the determining of the demographic data descriptive of each patron of the plurality of patrons of the venue comprises:
querying a database utilizing the identifier for each patron of the plurality of patrons of the venue.

8. The method of claim 7, wherein the database comprise one or more third-party databases.

9. The method of claim 1, wherein the compiling of the demographic summary descriptive of the venue, comprises:
compiling a graph of the plurality of patrons of the venue based on one or more of physical heights and physical weights for each patron of the plurality of patrons of the venue.

10. The method of claim 1, wherein the compiling of the demographic summary descriptive of the venue, comprises:
compiling a graph of the plurality of patrons of the venue based on mailing address information for each patron of the plurality of patrons of the venue.

11. The method of claim 1, wherein the receiving of the request for the demographic information from the mobile device of the user, comprises:
receiving an indication of a geographic location of the mobile device; and
identifying, based on the geographic information of the mobile device, the venue.

12. The method of claim 1, wherein the receiving of the request for the demographic information from the mobile device of the user, comprises:
receiving an indication of a selection of the venue, by the user, from a menu of a plurality of available venues.

13. The method of claim 1, wherein the receiving of the request for the demographic information from the mobile device of the user, comprises:
receiving an indication of a demographic preference defined by the user.

14. The method of claim 13, further comprising:
identifying, based on the demographic preference of the user, the venue.

15. The method of claim 13, wherein the compiling of the demographic summary descriptive of the venue is further based on the demographic preference of the user.

16. The method of claim 1, wherein the demographic summary descriptive of the venue comprises a summary of a real-time composition of the plurality of patrons of the venue.

17. The method of claim 1, wherein the demographic summary descriptive of the venue comprises a summary of a historic composition of the plurality of patrons of the venue.

18. A system, comprising:
a computerized processing device; and
a memory in communication with the computerized processing device, the memory storing instructions that when executed by the computerized processing device, result in:
receiving, from a data gathering device at a venue, an indication of an identifier for each patron of a plurality of patrons of the venue and an indication of a status of each patron of the plurality of patrons of the venue;
determining, based on the identifiers of the patrons, demographic data descriptive of each patron of the plurality of patrons of the venue;
compiling, based on the demographic data descriptive of each patron of the plurality of patrons of the venue, a demographic summary descriptive of the venue;
receiving, from a mobile device operated by a user, a request for demographic information; and
transmitting in response to the receiving of the request for the demographic information, and to the mobile device operated by the user, a signal that causes the mobile device to display a graphical representation of the demographic summary descriptive of the venue.

19. The system of claim 18, further comprising:
the data gathering device at the venue.

20. A non-transitory computer readable medium storing instructions that when executed by an electronic processing device, result in:
receiving, from a data gathering device at a venue, an indication of an identifier for each patron of a plurality of patrons of the venue and an indication of a status of each patron of the plurality of patrons of the venue;
determining, based on the identifiers of the patrons, demographic data descriptive of each patron of the plurality of patrons of the venue;
compiling, based on the demographic data descriptive of each patron of the plurality of patrons of the venue, a demographic summary descriptive of the venue;
receiving, from a mobile device operated by a user, a request for demographic information; and
transmitting in response to the receiving of the request for the demographic information, and to the mobile device operated by the user, a signal that causes the mobile device to display a graphical representation of the demographic summary descriptive of the venue.
